(19) United States
(12) Patent Application Publication
(10) Pub. No.: US 2015/0177666 A1
(43) Pub. Date: Jun. 25, 2015

(54) PRINTING APPARATUS, PRINTING SYSTEM, PRINTING METHOD AND NON-TRANSITORY RECORDING MEDIUM

(71) Applicant: CASIO COMPUTER CO., LTD., Tokyo (JP)

(72) Inventors: Toshihiko NUMAZU, Sayama-shi (JP); Toshio NAGASAKA, Iruma-shi (JP); Toshiaki YAJIMA, Iruma-shi (JP)

(73) Assignee: CASIO COMPUTER CO., LTD., Tokyo (JP)

(21) Appl. No.: 14/562,171

(22) Filed: Dec. 5, 2014

(30) Foreign Application Priority Data
Dec. 25, 2013 (JP) 2013-266523

(51) Int. Cl. G03G 15/00

(52) U.S. Cl. CPC G03G 15/6517

(57) ABSTRACT

A printing apparatus prints an image on a recording medium unwound by an unwinder. The recording medium is wound around a first winding shaft in order from a beginning edge to an ending edge of the recording medium. The wound recording medium is rewound, and the rewound recording medium is wound around a second winding shaft in order from the ending edge to the beginning edge of the recording medium.

### CROSS-REFERENCE TO RELATED APPLICATION

This application claims the benefit of Japanese Patent Application No. 2013-266523, filed on Dec. 25, 2013, the entire disclosure of which is incorporated by reference herein.

### FIELD

This application relates generally to a printing apparatus, printing system, printing method and non-transitory recording medium.

### BACKGROUND

As a recording medium for an image-forming apparatus such as a printer, a copier, a facsimile machine and/or the like to form images, a roll-wound recording medium (hereafter called roll paper) in which a recording medium such as paper, film and/or the like is wound around a roll shape exists. The roll paper can be stored without needing to be cut, and thus is widely used when accomplishing large-area image formation without a break, for example in a label printer continuously printing multiple labels or seals.

Accompanying increases in printing quality with digital printing, even with large-area printing using roll paper, quality close to that of printed materials such as flexography, gravure printing, offset printing and/or the like is needed. Consequently, printing with white, transparent and other colors on the roll paper is demanded, in addition to the four colors of YMCK (yellow (Y), magenta (M), cyan (C) and black (K)) that can be used with typical color printers under a four-way tandem method.

Printers corresponding to five-way or more tandem methods are known as a method of adding white and/or other colors to the four colors of YMCK in color printers (for example, see Unexamined Japanese Patent Application Kokai Publication No. 2011-174984).

In addition, a method of creating the K color (black) out of YMCK by superimposing the three colors of YMC (process black) and adding another color in place of the K color is known.

### SUMMARY

A printing apparatus according to a first aspect of the present disclosure comprises:

a printing unit that prints images on a recording medium unwound by an unwinder;

a first winder that winds the printed recording medium around a first winding shaft in order from a beginning edge to an ending edge of the recording medium; and

a second winder that rewinds the recording medium wound around the first winding shaft, and winds the rewound recording medium around a second winding shaft in order from the ending edge to the beginning edge of the recording medium.

A printing system according to a second aspect of the present disclosure comprises:

a first image-forming unit that forms a first developing agent image on a recording medium unwound by a first unwinder;

a first winder that winds the recording medium on which the first developing agent image was formed around a first winding shaft in order from a beginning edge to an ending edge of the recording medium;

a second winder that rewinds the recording medium wound around the first winding shaft, and winds the unwound recording medium around a second winding shaft in order from the ending edge to the beginning edge of the recording medium;

a second unwinder that unwinds the recording medium wound around the second winding shaft in order from the beginning edge to the ending edge of the recording medium; and

a second image-forming unit that forms a second developing agent image on a surface of the recording medium unwound by the second unwinder on which the first developing agent image was formed.

A printing method according to a third aspect of the present disclosure includes:

forming a first developing agent image on an unwound recording medium;

winding the recording medium on which the first developing agent image was formed around a first winding shaft, in order from a beginning edge to an ending edge of the recording medium;

rewinding the recording medium wound around the first winding shaft, and winding the rewound recording medium around a second winding shaft, in order from the ending edge to the beginning edge of the recording medium;

unwinding the recording medium wound around the second winding shaft, in order from the beginning edge to the ending edge of the recording medium; and

forming a second developing agent image on a surface of the unwound recording medium on which the first developing agent image was formed.

A non-transitory computer-readable recording medium according to a fourth aspect of the present disclosure has stored thereon a program executable by a computer, the program controlling the computer to perform functions comprising:

forming a first developing agent image on an unwound recording medium;

winding the recording medium on which the first developing agent image was formed around a first winding shaft, in order from a beginning edge to an ending edge of the recording medium;

rewinding the recording medium wound around the first winding shaft, and winding the rewound recording medium around a second winding shaft, in order from the ending edge to the beginning edge of the recording medium;

unwinding the recording medium wound around the second winding shaft, in order from the beginning edge to the ending edge of the recording medium; and

forming a second developing agent image on a surface of the unwound recording medium on which the first developing agent image was formed.

### BRIEF DESCRIPTION OF THE DRAWINGS

A more complete understanding of this application can be obtained when the following detailed description is considered in conjunction with the following drawings, in which:

FIG. 1 is a drawing showing the composition of a printing system according to a first exemplary embodiment of the present disclosure;

FIG. 2A is side view of a winding apparatus;

FIG. 2B is an oblique view of the winding apparatus;

FIG. 3A is a cross-sectional view showing the internal composition of a first image-forming apparatus;

FIG. 3B is a cross-sectional view showing the internal composition of a second image-forming apparatus;

FIG. 4 is a block diagram showing a composition relating to control of the first image-forming apparatus, the second image-forming apparatus and a terminal apparatus;

FIG. 5A is a drawing showing an example of image data of a printing target;

FIG. 5B is a drawing showing an example of normal color image data;

FIG. 5C is a drawing showing an example of special color image data;

FIG. 6 is a drawing showing a state preparing for printing in the printing system;

FIG. 7 is a block diagram showing a composition relating to control of a first paper supply apparatus, a second paper supply apparatus and a winding apparatus;

FIG. 8A is a drawing showing roll paper supplied from the first paper supply apparatus;

FIG. 8B is a drawing showing roll paper after image formation by the first image-forming apparatus;

FIG. 9A is a front view and a side view showing the state when the winding apparatus accomplishing a first winding;

FIG. 9B is an oblique view showing the state when the winding apparatus accomplishes the first winding;

FIGS. 10A and 10B are a front view and a side view showing the state when the winding apparatus accomplishes a second winding;

FIG. 11 is a drawing showing the state when the roll paper wound by the winding apparatus is attached to the holder of the second paper supply apparatus;

FIG. 12A is a drawing showing the roll paper supplied from the second paper supply apparatus;

FIG. 12B is a drawing showing the roll paper after image formation by the second image-forming apparatus;

FIG. 13 is a first flowchart showing the flow of processes executed in the printing system according to the first exemplary embodiment;

FIG. 14 is a second flowchart showing the flow of processes executed in the printing system according to the first exemplary embodiment;

FIG. 15 is a flowchart showing the flow of processes executed in the winding apparatus;

FIG. 16 is a drawing showing the composition of a printing system according to a second exemplary embodiment of the present disclosure;

FIG. 17 is a drawing showing the state when the second image formation is accomplished in the printing system according to the second exemplary embodiment;

FIG. 18 is a drawing showing the composition of a printing system according to a third exemplary embodiment of the present disclosure; and

FIG. 19 is a drawing showing the state when the second image formation is accomplished in the printing system according to the third exemplary embodiment;

### DETAILED DESCRIPTION

Below, the exemplary embodiments of the present disclosure are described with reference to the drawings. Parts that are the same or corresponding in the drawings are labeled with the same reference symbols.

### First Exemplary Embodiment

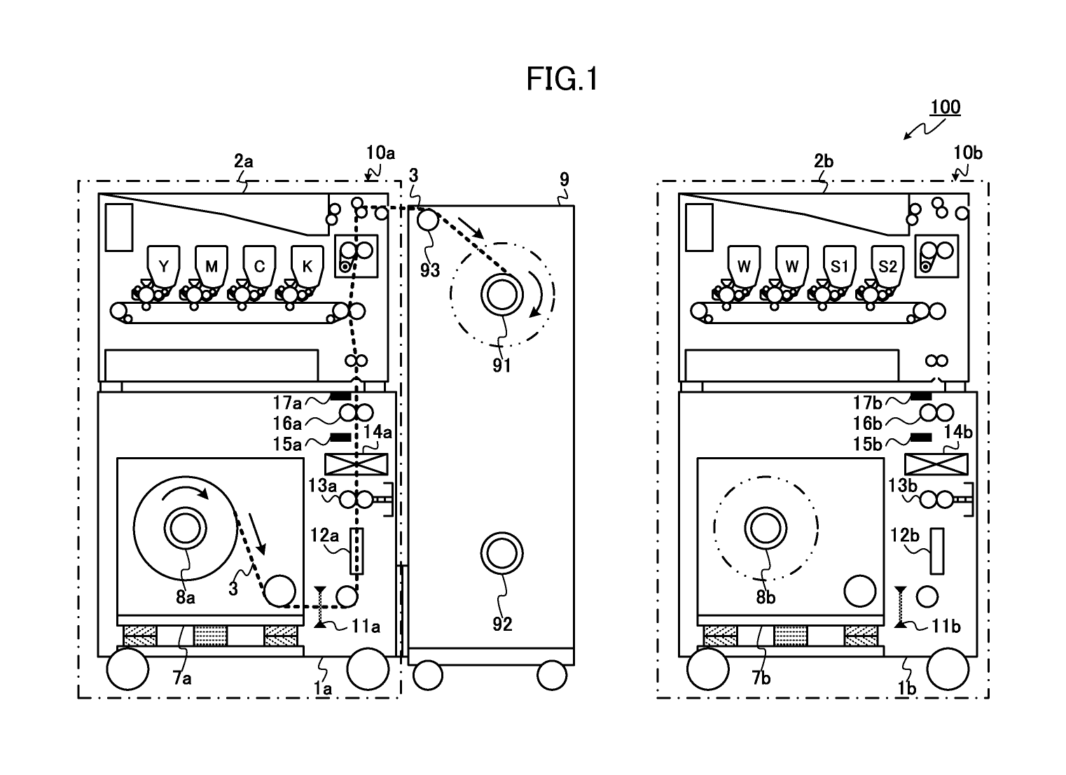

FIG. 1 shows the composition of a printing system according to a first exemplary embodiment. The printing system 100 comprises a normal color printing system 10a comprising a paper supply apparatus 1a and an image-forming apparatus 2a, a special color printing system 10b comprising a paper supply apparatus 1b and an image-forming apparatus 2b, and a winding apparatus 9. The printing system 100 prints in multiple colors on roll paper 3 that is a roll-wound recording medium, by using the normal color printing system 10a and the special color printing system 10b.

The paper supply apparatus 1a provided in the normal color printing system 10a supplies the roll paper 3 to the image-forming apparatus 2a. The paper supply apparatus 1a continuously unwinds the roll paper 3 in which paper is wound in a rolled sate around a prescribed winding core (paper tube) and conveys the roll paper 3 to the image-forming apparatus 2a along a prescribed conveyance path. Specifically, the paper supply apparatus 1a comprises a slide table 7a, a holder 8a, an incline detection sensor 11a, a side guide 12a, a paired conveyor roller 13a, an auto cutter 14a, a mark sensor 15a, a paired feed roller 16a and a feed sensor 17a.

The holder 8a functions as a first holder and holds the roll paper 3 prior to an image being formed by the image-forming apparatus 2a. The holder 8a comprises a rotatable rotation shaft that holds the roll paper 3 via the winding core at the winding center of the roll paper 3, and a support table that supports the rotation shaft, and supports the roll paper 3 so that rotation is possible.

An unrepresented motor for causing the rotation shaft to rotate is mounted in the holder 8a. The holder 8a functions as an unwinder that unwinds the roll paper 3 held by causing the rotation shaft to rotate an indicated number of rotations per unit time (the number of times rotated per unit time) under driving by the motor.

In addition, an unrepresented powder brake is attached to the rotation shaft of the holder 8a. The powder brake applies a brake to rotation of the rotation shaft so that the tension applied to the roll paper conveyed by being unwound from the holder 8a is kept constant. Through the function of the powder brake, the roll paper 3 unwound from the holder 8a is conveyed stably without slackening.

The slide table 7a is provided with a slide bearing on both sides and causes the holder 8a to slide in the direction of the rotation shaft (the sideways direction of the roll paper 3). When the slide table 7a detects an incline of the roll paper 3 conveyed inside the paper supply apparatus 1a, drive force is obtained through an actuator and causes the holder 8a to move in a direction to negate the detected incline.

The incline detection sensor 11a detects inclines of the roll paper 3 conveyed inside the paper supply apparatus 1a. Specifically, the incline detection sensor 11a comprises multiple sets of light-emitting elements and light-receiving elements positioned so that interposed in between is the end of the roll paper 3 in the sideways direction. The incline detection sensor 11a determines the position deviation of the end of the roll paper 3 in the sideways direction without contacting the roll paper 3, by determining whether or not light emitted from the light-emitting elements is received by the light-receiving elements without being blocked, for each of the multiple sets.

The paired conveyor roller 13a sandwiches and conveys the roll paper 3 unwound from the holder 8a and conveyed via the following roller and the side guide 12a, and supplies the roll paper 3 to the paired feed roller 16a. The paired feed roller 16a sandwiches and conveys the roll paper 3 supplied from the paired conveyor roller 13a, and supplies the roll paper 3 to the image-forming apparatus 2a.

The auto cutter 14a cuts the roll paper 3 as necessary. The auto cutter 14a cuts the final end (back edge) of the roll paper 3 for example when roll paper 3 of a length necessary for image formation in the image-forming apparatus 2a has finished being conveyed.

The mark sensor 15a detects an original mark recorded on the surface of the roll paper and used by the image-forming apparatus 2a as a position reference for forming images. Specifics of the original mark are described below.

The feed sensor 17a detects the beginning edge (front edge) of the roll paper 3 fed to the image-forming apparatus 2a from the paired feed roller 16a. Specifically, the feed sensor 17a comprises a light-emitting element and a light-receiving element, and determines that the beginning edge of the roll paper 3 has been detected when light emitted from the light-emitting element is blocked by the beginning edge of the roll paper 3 and is not detected by the light-receiving element. When the feed sensor 17a detects the beginning edge of the roll paper 3, the image-forming apparatus 2a starts driving of the various types of roller pairs and causes the roll paper 3 fed to the inside to be conveyed.

The paper supply apparatus 1b with which the special color printing system 10b is equipped supplies roll paper 3 to the image-forming apparatus 2b as a recording medium for image formation. Specifically, the paper supply apparatus 1b comprises a slide table 7b, a holder 8b, an incline detection sensor 11b, a slide guide 12b, a paired conveyor roller 13b, an auto cutter 14b, a mark sensor 15b, a paired feed roller 16b and a feed sensor 17b. The holder 8b functions as a second holder and holds the roll paper 3 after an image is formed by the first image-forming apparatus 2a and the paper is wound by a winder 97. The paper supply apparatus 1b has the same composition as the above-described paper supply apparatus 1a, so detailed explanation of the various constituent elements comprising the paper supply apparatus 1b is omitted.

A winding apparatus 9 comprises a first winding shaft 91, a second winding shaft 92 and a guide roller 93. The winding apparatus 9 functions as a rewinder, and winds and holds the roll paper 3 ejected from the image-forming apparatus 2a and conveyed via the guide roller 93 around the first winding shaft 91. In addition, the winding apparatus 9 unwinds the roll paper 3 wound around the first winding shaft 91, and again winds the roll paper 3 around the second winding shaft 92.

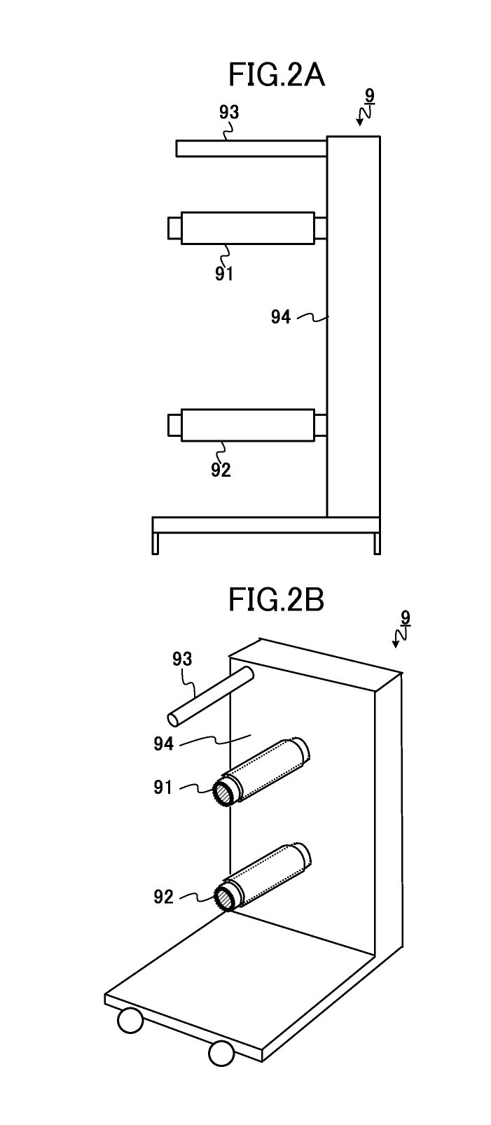

More specifically, as shown in FIG. 2A and FIG. 2B, the first winding shaft 91, the second winding shaft 92 and the guide roller 93 are positioned on a side surface 94 so that the respective shaft directions are perpendicular to the common side surface 94 in the winding apparatus 9. Because the first winding shaft 91 and the second winding shaft 92 are positioned on the common side surface 94, it is possible for the first winding shaft 91 to unwind the wound roll paper 3 and for the second winding shaft 92 to smoothly wind the roll paper 3 again. In addition, the winding apparatus 9 is provided on the bottom with wheels for moving and can be mounted on either the normal color printing system 10a or and the special color printing system 10b.

Unrepresented motors are provided in the first winding shaft 91 and the second winding shaft 92, and wind the roll paper 3 by rotating at a number of rotations per unit time specified through driving by the motors. In addition, the first winding shaft 91 is provided with a clutch mechanism for interrupting the transfer of drive power from the motor when excessively large torque is applied. Through this, the roll paper 3 that is being wound is prevented from being pulled excessively tight so that the precision of image formation declines.

The image-forming apparatus 2a with which the normal color printing system 10a is equipped is placed on top of the paper supply apparatus 1a and functions as a first image-forming unit that forms (transfers and fixes) a first developing agent image through developing agent in the four colors of YMCK (yellow (Y), magenta (M), cyan (C) and black (K)) based on image data of the printing target, and forms the first developing agent image on the roll paper 3 supplied from the paper supply apparatus 1a. The image-forming apparatus 2b with which the special color printing system 10b is equipped is placed on top of the paper supply apparatus 1b and functions as a second image-forming unit that forms a second developing agent image through developing agent of special colors not included in the four colors of YMCK and forms the second developing agent image on the roll paper 3 supplied from the paper supply apparatus 1b.

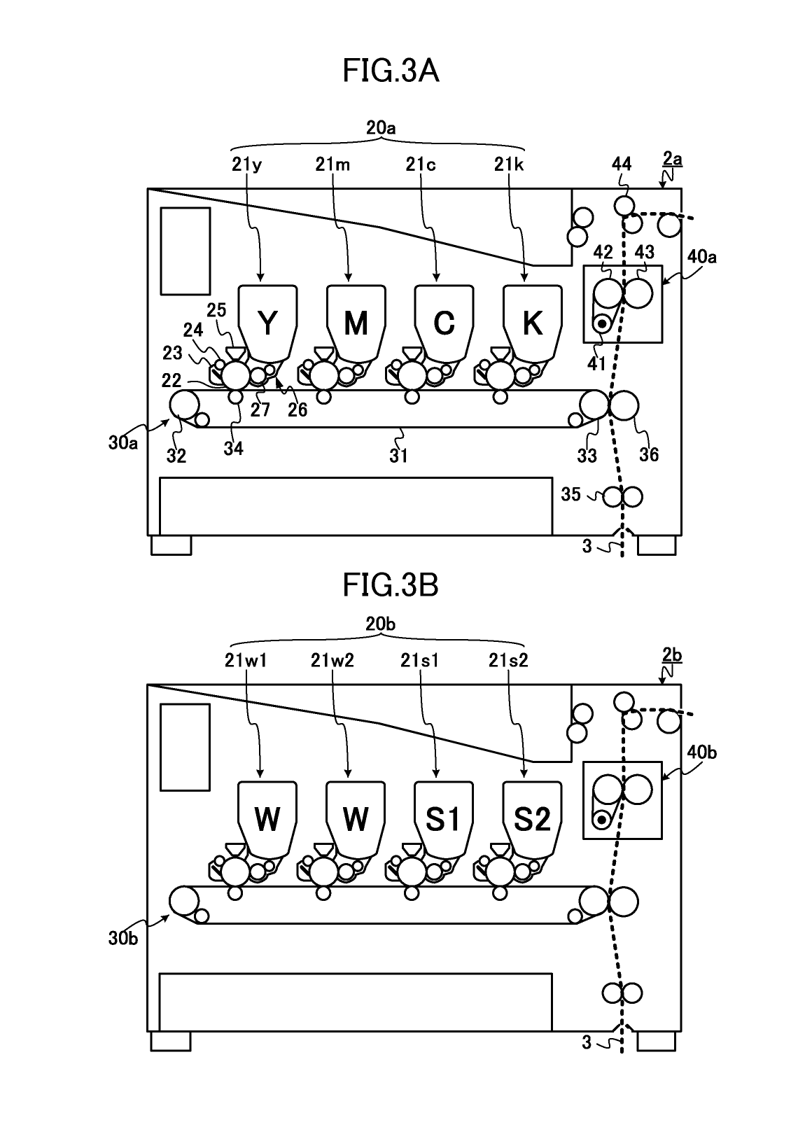

The internal compositions of the image-forming apparatus 2a and the image-forming apparatus 2b is described with reference to FIG. 3A and FIG. 3B. Below, the image-forming apparatus 2a and the image-forming apparatus 2b are described by taking as an example a secondary transfer-type tandem color printer of electronic photo format. In addition, the explanation below takes as an example a case in which toner is used as the developing agent.

As shown in FIG. 3A, the image-forming apparatus 2a comprises an image-forming unit 20a, an intermediate transfer belt unit 30a and a fuser apparatus 40a.

The image-forming apparatus 20a is provided with a composition in which four Image-forming parts 21y, 21m, 21c and 21k are arranged linearly. The Image-forming parts 21y, 21m and 21c form color images through color toner of yellow (Y), magenta (M) and cyan (C), which are the three primary colors of subtractive mixture colors. On the other hand, the Image-forming part 21k forms monochrome images of black (K) toner used primarily in text and dark parts of images, and or the like.

Each of the Image-forming parts 21 comprises a photosensitive drum 22 at the bottom. This photosensitive drum 22 comprises an organic photoconductive material, for example, on a cylinder surface. Near the photosensitive drum 22, a cleaner 23, a charged roller 24, an optical writing head 25 and a developing roller 27 of a developer 26 are positioned as though surrounding the cylinder surface.

The developer 26 stores toner of yellow (Y), magenta (M), cyan (C) and black (K) in a toner container positioned on top, in the center is provided with a toner replenishing mechanism to the bottom, and on the bottom is provided with the developing roller 27. The developer 26 is further equipped with a toner stirrer inside, a toner supply roller for supplying toner to the developing roller 27, and a doctor blade for regulating the toner layer on the developing roller 27 to a constant thickness.

Reference symbols are appended to only the composition of the Image-forming part 21y for yellow (Y) in FIG. 3A and FIG. 3B, but each of the Image-forming parts 21 (21y, 21m, 21c, 21k, 21w1, 21w2, 21s1 and 21s2) have the same composition excepting for the color of the toner stored in the toner container.

The intermedia transfer belt unit 30a comprises an endless transfer belt 31 extending in a flat loop shape substantially in the center of the image-forming apparatus 2a; a driving roller 32 over which the transfer belt 31 is passed, the driving roller 32 causing the transfer belt 31 to circulate and move in a counter-clockwise direction; and a following roller 33. The transfer belt 31 conveys the toner image transferred (primary transfer) directly to the belt surface to the transfer position so that toner image on the belt surface can transfer (secondary transfer) to the roll paper 3.

The intermediate transfer belt unit 30a is provided with four primary transfer rollers 34 corresponding to the four Image-forming parts 21y, 21m, 21c, 21k, within the loop of the transfer belt 31. The primary transfer rollers 34 comprise conductive foam sponges for pressing against the bottom cylinder surface of the photosensitive drum 22 via the transfer belt 31, and rotate with a specified rotation period and cause the transfer belt 31 to abut the photosensitive drum 22 and separate from the photosensitive drum 22.

A paired standby conveyor roller 35 receives the roll paper 3 supplied from the paper supply apparatus 1 via a feed opening for expansion paper supply, and conveys the roll paper 3 received to a secondary transfer roller 36. The secondary transfer roller 36 is positioned so as to press against the following roller 33 via the transfer belt 31, and forms a secondary transfer unit that makes a secondary transfer to the roll paper 3 of the toner image transferred to the belt surface of the transfer belt 31.

The fuser apparatus 40a comprises a heating roller 42 into which a heater 41 is built, and a pressure roller 43 that presses against the heating roller 42. The fixing apparatus 40a heats and presses on, thereby fixing, the unfixed toner on the roll paper 3 after secondary transfer.

In addition, on the downstream side of the fuser apparatus 40a, a paper discharge roller pair 44 is positioned for discharging the roll paper 3 from the image-forming apparatus 2a after toner fixing. The roll paper 3 that has passed through the paper discharge roller pair 44 is discharged from the image-forming apparatus 2a and is wound by the winding apparatus 9.

As shown in FIG. 3B, the image-forming apparatus 2b comprises an image-forming unit 20b, an intermediate transfer belt unit 30b and a fuser apparatus 40b. The image-forming apparatus 2b has the same composition as the image-forming apparatus 2a with the exception of the color of toner stored in the four Image-forming parts 21w1, 21w2, 21s1 and 21s2 in the image-forming unit 20b. Consequently, detailed description of the other constituent elements comprising the image-forming apparatus 2b is omitted.

The image-forming unit 20b is provided with a composition in which four Image-forming parts 21w1, 21w2, 21s1 and 21s2 that form images using toner of colors not including the four colors of YMCK are arranged linearly. By using toner of special colors, it is possible to express colors that cannot be expressed by the four colors of YMCK and it is possible to increase the quality of printed materials.

Specifically, the Image-forming parts 21w1 and 21w2 both comprise toner containers containing white (W) toner and form images with white toner. That is to say, the image-forming apparatus 2b forms white toner images respectively with the two Image-forming parts 21w1 and 21w2, and forms white images by superimposing the two white toner images on the transfer belt 31. By superimposing two white toner images, it is possible to express images with white of sufficient depth without the base colors becoming transparent, even when for example images are formed in areas where base colors such as black or red are deep.

On the other hand, the Image-forming parts 21s1 and 21s2 respectively comprise toner containers containing toner of special colors other than white and form images through the special-colored toner. As special colors other than white, gold, silver, transparent (invisible) colors that emit light when irradiated with ultraviolet rays and special colors for providing fluorescent light or gloss, and/or the like, can be cited. The Image-forming parts 21s1 and 21s2 form images through toner of at least one or more of these colors.

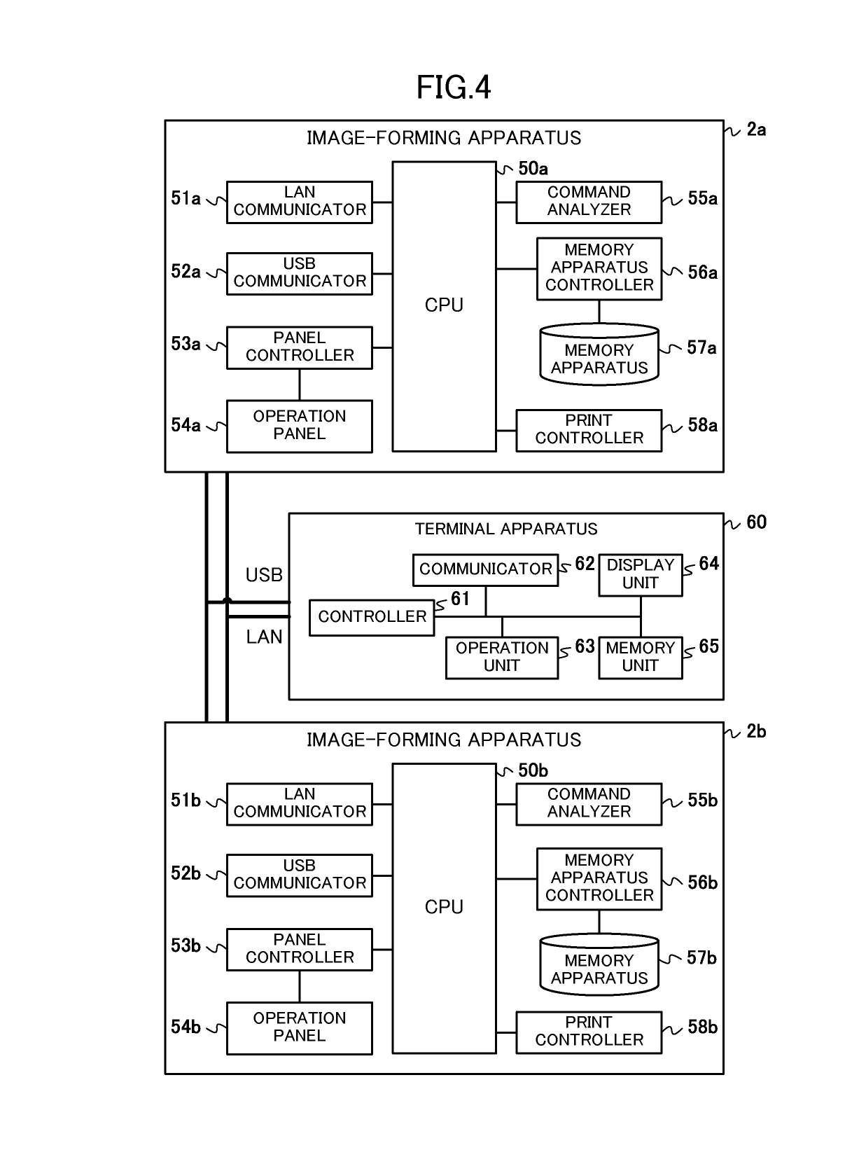

Next, referring to FIG. 4, the composition relating to control of the image-forming apparatus 2a and the image-forming apparatus 2b is described. The image-forming apparatus 2a and the image-forming apparatus 2b are connected to each other by a terminal apparatus 60 and a network such as a LAN (Local Area Network) and/or the like or a USB (Universal Serial Bus).

The image-forming apparatus 2a comprises a CPU (Central Processing Unit) 50a, a LAN communicator 51a, a USB communicator 52a, a panel controller 53a, an operation panel 54a, a command analyzer 55a, a memory apparatus controller 56a, a memory apparatus 57a and a print controller 58a.

The CPU 50a is connected to the various components of the image-forming apparatus 2a via a system bus that is a transmission route for transmitting commands and data, and controls the actions of the various components of the image-forming apparatus 2a. The CPU 50a, while using an unrepresented ROM (Read Only Memory) and RAM (Random Access Memory) as work memories, reads out various types of programs such as system software and/or the like stored in the ROM and the memory apparatus 57a and executes appropriately.

The LAN communicator 51a and the USB communicator 52a communicate with external equipment including the terminal apparatus 60, the paper supply apparatus 1a and the winding apparatus 9 via the LAN and USB, respectively.

The panel controller 53a is connected to the operation panel 54a comprising for example a display panel such as an LCD (Liquid Crystal Display) and/or the like and an input apparatus including various types of operation buttons. The panel controller 53a, under control of the CPU 50a, displays images and text and/or the like on the operation panel 54a and receives operations from a user input into the operation panel 54a.

The command analyzer 55a, under control of the CPU 50a, analyzes commands included in print data sent from the terminal apparatus 60 and converts the print data into bitmap image data. The command analyzer 55a develops the converted bitmap image data in a memory area corresponding to frame memory for each color of toner with which the image-forming apparatus 2a is equipped. The image data developed in the frame memory is output to the print controller 58a.

The memory apparatus 57a is non-volatile memory such as an EEPROM (Electrically Erasable Programmable ROM), HDD (Hard Disk Drive) and/or the like. The memory apparatus controller 56a, under control of the CPU 50a, controls writing of data to the memory apparatus 57a and reading of data stored in the memory apparatus 57a.

The print controller 58a, under control of the CPU 50a, controls the printing mechanism including the image-forming unit 20a, the intermediate transfer belt unit 30a and the fuser apparatus 40a, and accomplishes a printing process in accordance with image data generated by the command analyzer 55a.

The image-forming apparatus 2b comprises a CPU 50b, a LAN communicator 51b, a USB communicator 52b, a panel controller 53b, an operation panel 54b, a command analyzer 55b, a memory apparatus controller 56b, a memory apparatus 57b and a printing controller 58b. The image-forming apparatus 2b has a composition relating to control the same as the image-forming apparatus 2a, so detailed description is omitted.

The terminal apparatus 60 is for example an information processing apparatus such as a PC (Personal Computer) and/or the like, and is connected to the two image-forming apparatuses 2a and 2b via the LAN and the USB. The terminal apparatus 60 comprises a controller 61, a communicator 62, an operation unit 63, a display unit 64 and a memory unit 65.

The controller 61 comprises for example a CPU and RAM and/or the like that functions as a main memory of the CPU. The controller 61 is connected to each component of the terminal apparatus 60 via a system bus that is a transmission route for transmitting commands and data, and controls the terminal apparatus 60 as a whole.

The communicator 62, under control of the controller 61, communicates with the two image-forming apparatuses 2a and 2b via the USB or the LAN.

The operation unit 63 comprises an input apparatus such as a mouse, keyboard and/or the like. The operation unit 63 receives operations from a user. For example, the operation unit 63 supplies to the controller 61 a signal for setting print conditions or a signal for executing printing.

The display unit 64 comprises for example a display device such as a CRT (Cathode Ray Tube), an LCD and/or the like. The display unit 64 displays on a screen images based on image data supplied from the controller 61.

The memory unit 65 comprises for example a memory apparatus such as an HDD, ROM, flash memory and/or the like. The memory unit 65 stores programs and data the controller 61 uses for executing various types of processes, including printer drivers for printing in multiple colors using the two image-forming apparatuses 2a and 2b.

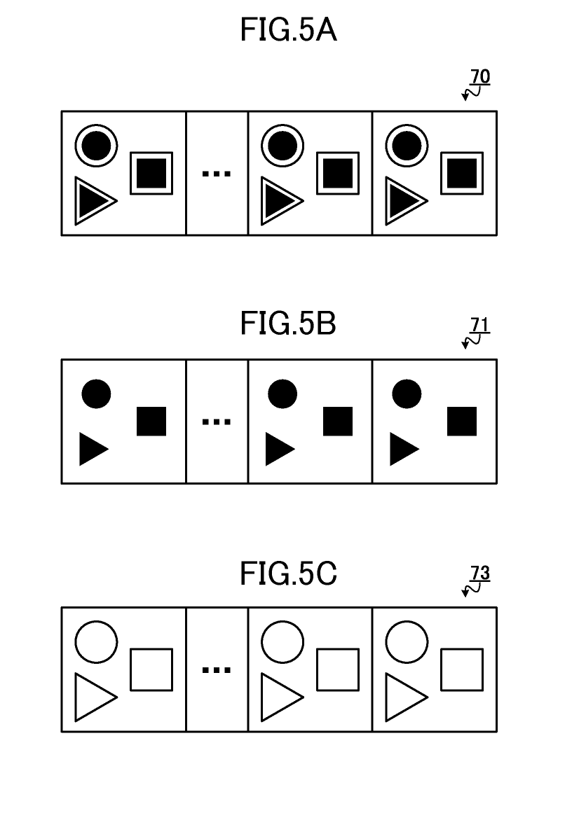

As shown in FIG. 5A as an example, the description is for a case in which image data 70 of multiple labels with the various labels comprising the figures of a square, a circle and a triangle are printed to the roll paper 3 from the terminal apparatus 60 using the printing system 100.

When a user operates the operation unit 63 and accomplishes a print command for image data 70 of a printing target via a prescribed application, the controller 61 generates image data for the normal color printing system 10a and image data for the special color printing system 10b in accordance with the printer driver stored in the memory unit 65.

To explain more specifically, the controller 61 extracts image data that should be output with black (K) toner from the image data 70 of the printing target as image data for the normal color printing system 10a, and generates normal color image data 71 for example as shown in FIG. 5B. When color printing is commanded, the controller 61 further generates the image data that should be output with toner of the colors YMC as image data for the normal color printing system 10a.

In addition, the controller 61 extracts image data that should be output with special colors of toner from the image data 70 of the printing target, as image data for the special color printing system 10b, and generates special color image data 73 for example as shown in FIG. 5C. When printing using multiple types of special colors is commanded, the controller 61 generates the multiple items of image data commanded as image data for the special color printing system 10b.

The controller 61 sends first print data including the generated normal color image data 71 and print conditions to the image-forming apparatus 2a via the communicator 62. In addition, the controller 61 sends second print data including the generated special color image data 73 and print conditions to the image-forming apparatus 2b via the communicator 62. The print conditions are setting conditions relating to image formation such as resolution and gradation value, and other printing setting conditions such as the size and type of roll paper 3 and printing range.

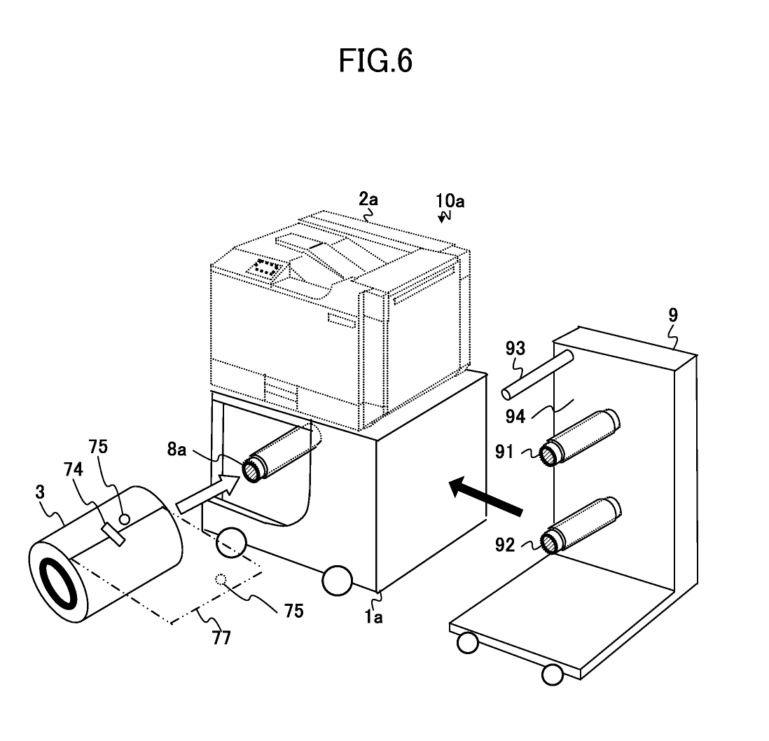

When the first and second print data are sent, the printing process in the printing system 100 starts. Prior to the start of printing, the user attaches the roll paper 3 prior to printing with a beginning edge 77 anchored by anchor-tape 74 to the holder 8a of the paper supply apparatus 1a, for example as shown in FIG. 6. Furthermore, the user causes the winding apparatus 9 to move and mounts such on the normal color printing system 10a, and makes preparations for winding the roll paper 3 the image-forming apparatus 2a discharges.

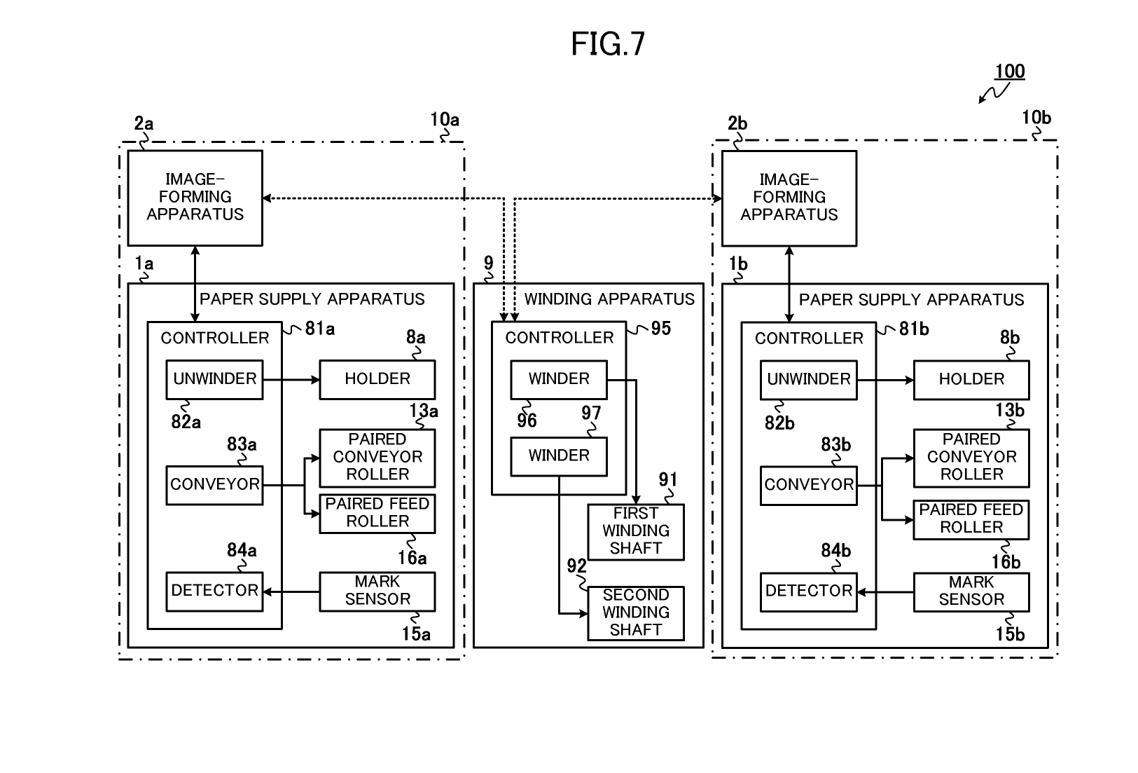

In a state in which printing preparations are thus concluded, when the first and second print data are sent from the terminal apparatus 60, the paper supply apparatuses 1a and 1b and the winding apparatus 9 are driven and printing starts. The composition relating to control of the paper supply apparatuses 1a and 1b and the winding apparatus 9 is described with reference to FIG. 7.

A controller 81a with which the paper supply apparatus 1a is equipped controls the actions of the paper supply apparatus 1a as a whole through the functions of an unrepresented CPU, RAM, ROM and/or the like. Specifically, the controller 81a functions as an unwinder 82a, conveyor 83a and detector 84a.

The unwinder 82a functions as a first unwinder and unwinds the roll paper 3 held by the holder 8a. That is to say, when a paper supply request is received from the image-forming apparatus 2a that has received the first print data, the unwinder 82a causes the rotation shaft of the holder 8a to rotate and unwinds the roll paper 3 installed on the holder 8a in order from the beginning edge 77. The conveyor 83a causes the paired conveyor roller 13a and the paired feed roller 16a to be driven and successively conveys to the image-forming apparatus 2a the roll paper 3 unwound by the unwinder 82a.

An original mark 75 is recorded in advance on the roll paper 3. The original mark 75 functions as a reference mark that is a position reference when the image-forming apparatus 2a forms images on the roll paper 3. The detector 84a functions as a first detector and detects by means of the mark sensor 15a the original mark 75 recorded on the roll paper 3 conveyed by the conveyor 83a after being unwound by the unwinder 82a.

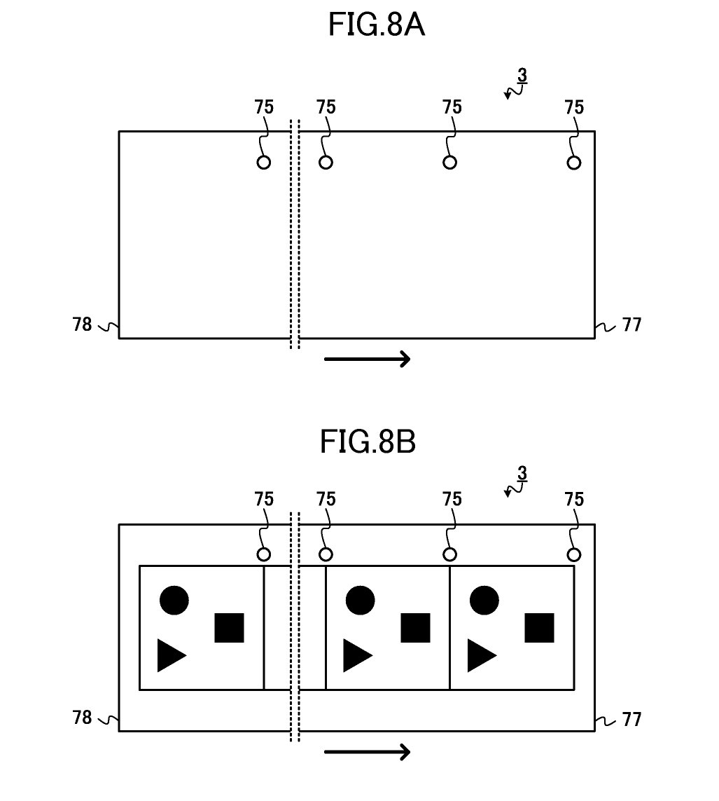

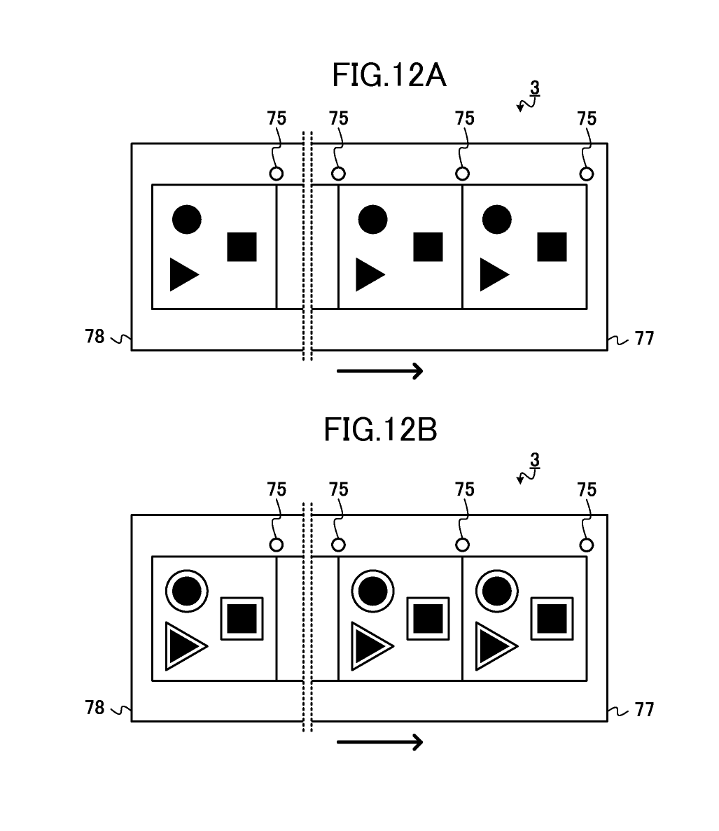

For example, as shown in FIG. 8A, the original mark 75 is recorded at fixed intervals at multiple positions from the beginning edge 77 to a ending edge 78 of the roll paper 3. The intervals are set to a length corresponding to the pitch of the labels in the image data 70 to be output, so that the image-forming apparatus 2a can adjust the position of image formation for each label. To facilitate understanding, FIG. 8A shows a state with the entirety of the roll paper 3 unwound and spread out. In addition, an arrow indicates the conveyance direction of the roll paper 3. The same is true in below-described FIG. 8B, FIG. 12A and FIG. 12B.

The image-forming apparatus 2a forms (develops) a first toner image of toner in the four colors of YMCK and forms (transfers, and fixes) the first toner image on the roll paper 3 conveyed by the conveyor 83a, based on the normal color image data 71 sent from the terminal apparatus 60. At this time, the image-forming apparatus 2a forms the first toner image on the roll paper 3 with the original mark 75 detected by the detector 84a as the position reference, so that the region in which the first toner image is formed does not shift up-and-down or left-and-right. As a result, an output image for multiple labels for example as shown in FIG. 8B is output to the roll paper 3. The roll paper 3 on which the first toner image is recorded is fixed by the fuser apparatus 40a and is discharged to the winding apparatus 9.

Returning to the explanation of FIG. 7, a controller 95 with which the winding apparatus 9 is equipped controls the actions of the winding apparatus 9 as a whole through the functions of an unrepresented CPU, RAM, ROM and/or the like.

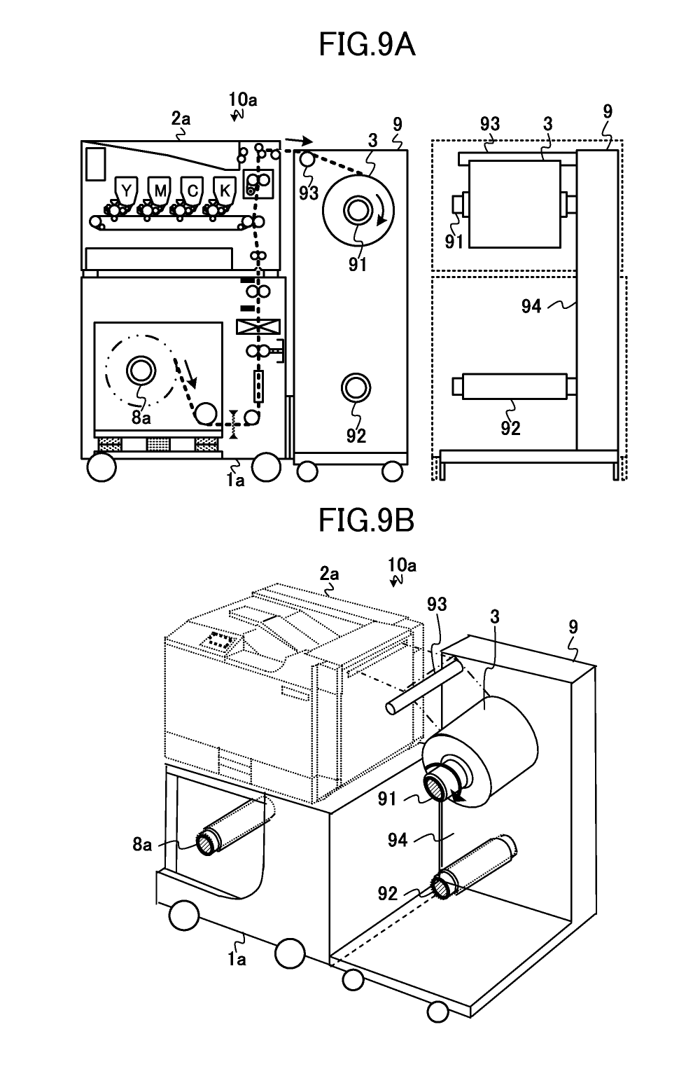

A winder 96 functions as a first winder and winds the first roll paper 3 on which the image-forming apparatus 2a printed (developed, transferred and fixed) the first toner image based on the normal color image data 71 around the first winding shaft 91 in order from the beginning edge 77 to the ending edge 78 of the roll paper 3. For example as shown in FIG. 9A and FIG. 9B, the winder 96, upon receiving a winding request for the roll paper 3 from the image-forming apparatus 2a, causes the first winding shaft 91 to rotate and starts winding the roll paper 3 discharged from the image-forming apparatus in order from the beginning edge 77 to the ending edge 78.

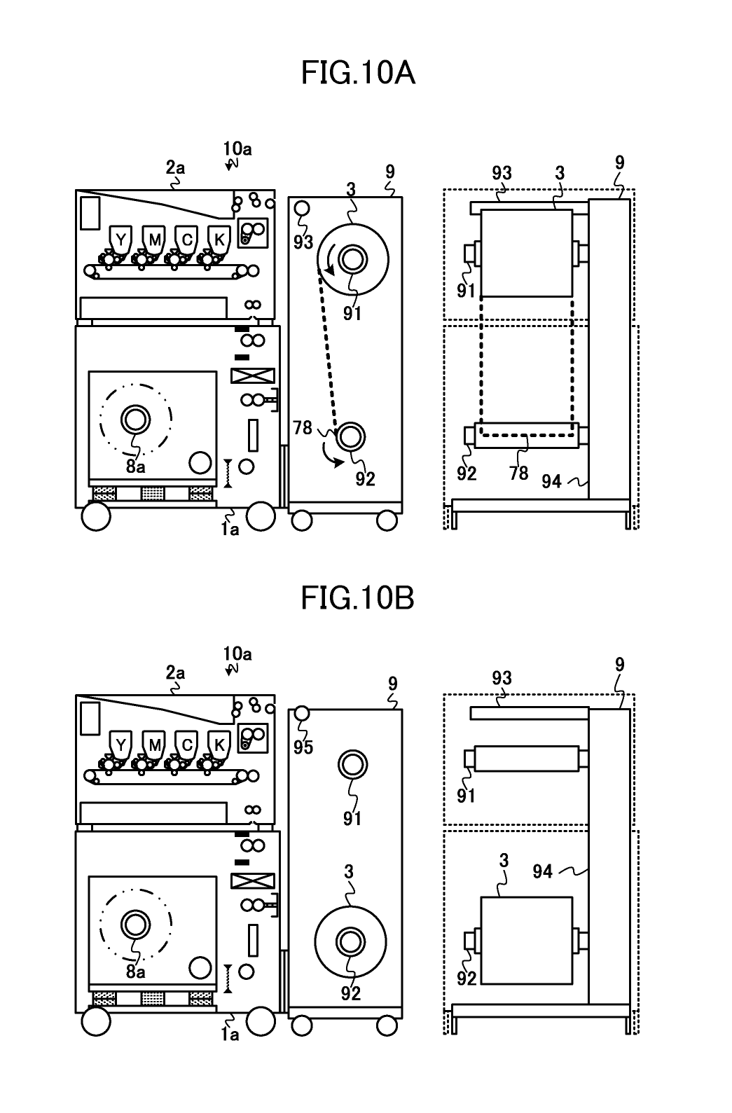

When the first winding concludes, the roll paper 3 is in a state wound with the beginning edge 77 on the inside and the ending edge 78 on the outside, and is held on the first winding shaft 91. From this state, the user anchors the ending edge 78 of the roll paper 3 to the second winding shaft 92 as shown in FIG. 10A, and prepares for the second winding (re-winding). At this time, for the paper tube mounted on the second winding shaft 92, it is possible to reuse the paper tube used by the holder 8a of the paper supply apparatus 1a in the normal color printing system 10a.

When preparation for the second winding concludes, the winder 97 starts re-winding the roll paper 3 by causing the second winding shaft 92 to rotate. That is to say, the winder 97 functions as a second winder, rewinds the roll paper 3 that the winder 96 wound around the winding shaft 91, and winds the rewound roll paper 3 around the second winding shaft 92 in order from the ending edge 78 to the beginning edge 77 of the roll paper 3.

During winding to the second winding shaft 92, the first winding shaft 91 follows the roll paper 3 unwound by rotational driving of the second winding shaft 92, and rotates in the opposite direction (the direction of the arrow in FIG. 10A) from the direction during winding to the first winding shaft 91 (the direction of the arrow in FIG. 9A). Consequently, the first winding shaft 91 is provided for example with a one-directional clutch, and is comprised so as to rotate in a first direction upon receiving driving power of the motor during the first winding and spins upon receiving torque in the opposite direction from the first direction when receiving driving power of the second winding shaft 92 during the second winding.

When the second winding concludes as shown in FIG. 10B, the roll paper 3 is held on the second winding shaft 92 in a state wound with the beginning edge 77 on the outside and the ending edge 78 on the inside. The beginning edge 77 of the roll paper 3 that has finished winding is temporarily anchored by anchor-tape 74.

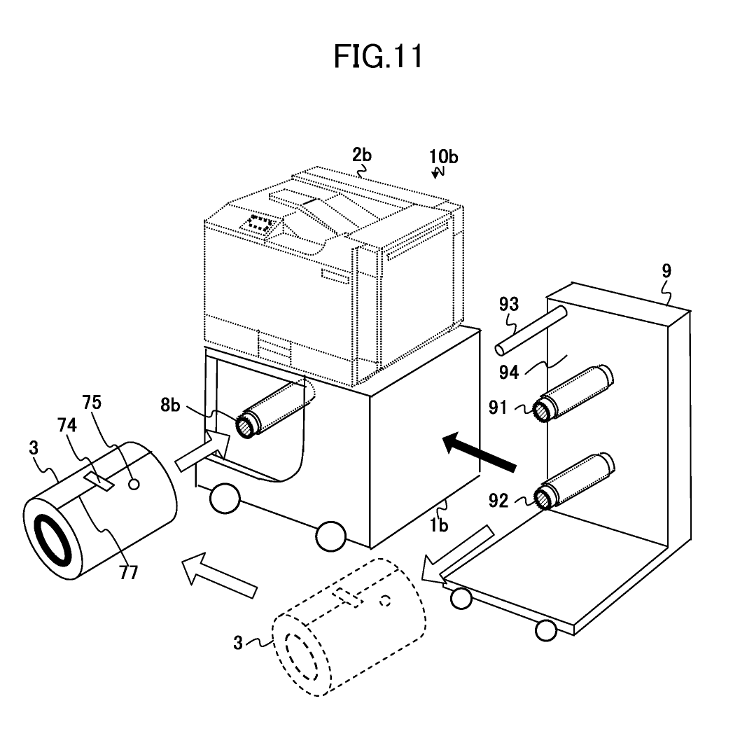

When winding by the winding apparatus 9 ends, as shown in FIG. 11 the user removes the roll paper 3 from the second winding shaft 92 in order to accomplish additional printing with special colors, and mounts the roll paper 3 on the holder 8b of the paper supply apparatus 1b of the special color printing system 10b. Furthermore, the user causes the winding apparatus 9 to move and mounts such on the special color printing system 10b, and prepares for winding of the roll paper 3 to be discharged by the image-forming apparatus 2b. The roll paper that has finished being wound by the winding apparatus 9 is in a state wound with the beginning edge 77 to the outside and the ending edge 78 on the inside, the same as prior to the start of printing, so mounting on the paper supply apparatus 1b of the special color printing system 10b in the same direction as the roll paper 3 mounted on the paper supply apparatus 1a of the normal color printing system 10a is possible.

Returning to FIG. 7, the composition relating to control of the special color printing system 10b is described. The controller 81b with which the paper supply apparatus 1b is equipped controls the actions of the paper supply apparatus 1b as a whole through the functions of an unrepresented CPU, RAM, ROM and/or the like. Specifically, the controller 81b functions as an unwinder 82b, a conveyor 83b and a detector 84b.

The unwinder 82b functions as a second unwinder, causes the rotation shaft of the holder 8b to rotate and unwinds the roll paper 3 attached to the holder 8b in order from the beginning edge 77 to the ending edge 78 of the roll paper 3. The conveyor 83b drives the paired conveyor roller 13b and the paired feed roller 16b and/or the like and successively conveys the roll paper 3 unwound by the unwinder 82b to the image-forming apparatus 2b. Specifically, as shown in FIG. 12A, the conveyor 83b conveys the roll paper 3 on which toner images in the normal colors (the four colors of YMCK) were formed with the beginning edge 77 in the lead.

The detector 84b functions as a second detector and detects, through the mark sensor 15b, the original mark 75 recorded on the roll paper 3 unwound by the unwinder 82b and conveyed by the conveyor 83b.

The image-forming apparatus 2b forms a second toner image through toner of special colors not included in YMCK, based on the special color image data 73 sent from the terminal apparatus 60. To explain specifically, the image-forming apparatus 2b forms two white toner images by means of the two Image-forming parts 21w1 and 21w2 that form images through white toner, and forms toner images in other special colors by means of the Image-forming parts 21s1 and 21s2 that form images through other special colors. Furthermore, by superimposing the two white toner images formed and the other special color toner images, a second toner image is formed. Furthermore, the second toner image is formed at the region (surface) in which the first toner image of the roll paper 3 conveyed by the conveyor 83b was formed.

At this time, the image-forming apparatus 2b forms the second toner image on the roll paper with the original mark 75 detected by the detector 84b as a position reference so that the region where the second toner image is formed does not shift to the front or back, or to the left or right. As a result, output images of multiple labels that reproduced the image data 70 of the printing target are output to the roll paper 3, as shown in FIG. 12B. The roll paper 3 on which the second toner image is formed is fixed by the fuser apparatus 40b and discharged to the winding apparatus 9.

In the winding apparatus 9, the winder 96 winds the roll paper 3 discharged from the image-forming apparatus 2b around the first winding shaft 91 in order from the beginning edge 77 to the ending edge 78. Furthermore, the winder 97 unwinds the roll paper 3 wound around the first winding shaft 91 and winds the roll paper 3 around the second winding shaft 92 in order from the ending edge 78 to the beginning edge 77. As a result, the roll paper 3 on which the desired multi-color ink printing was done obtains a wound state with the beginning edge 77 on the outside and the ending edge 78 on the inside, the same as prior to the start of printing.

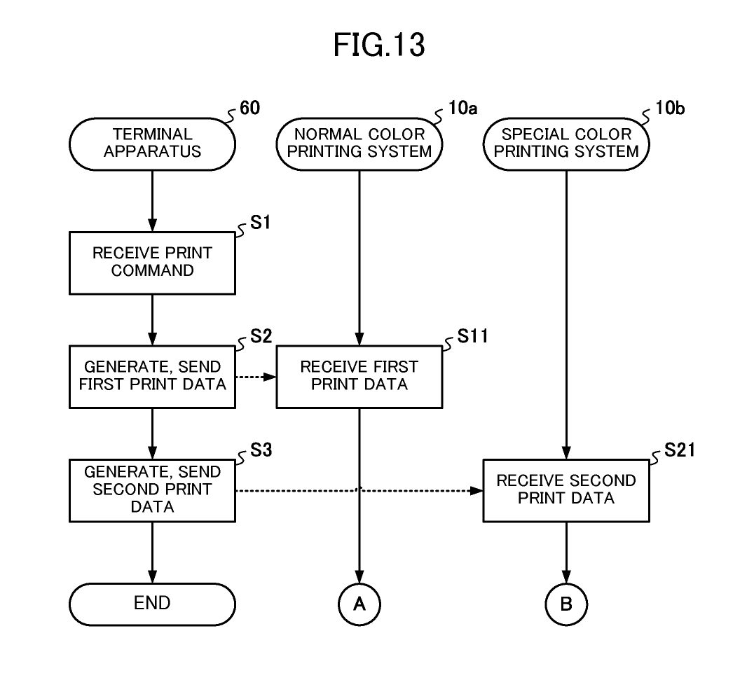

The flow of multi-color printing processes in the above kind of printing system 100 is explained with reference to the flowcharts shown in FIGS. 13-15.

The multi-color printing processes of the printing system 100 start in a state in which the roll paper 3 prior to printing is attached to the paper supply apparatus 1a in the normal color printing system 10a and the winding apparatus 9 is mounted, that is to say in a state in which printing preparations have concluded.

In the terminal apparatus 60, the controller 61, upon receiving a print command from the user via the operation unit 63 for example (step S1), starts the process in the flowchart shown in FIG. 13.

When the print command is received, the controller 61 generates first print data in accordance with the print command and sends the generated first print data to the image-forming apparatus 2a of the normal color printing system 10a (step S2). The first print data includes image data that should be output with the four colors of YMCK in the image data 70 of the printing target, and print conditions, as in the normal color image data 71 shown in FIG. 5B for example.

Along with generating and sending the first print data, the controller 61 generates second print data in accordance with the print command and sends the generated second print data to the image-forming apparatus 2b of the special color printing system 10b (step S3). The second print data includes image data that should be output in special colors other than YMCK in the image data 70 of the printing target, and print conditions, as in the special color image data 73 shown in FIG. 5C for example.

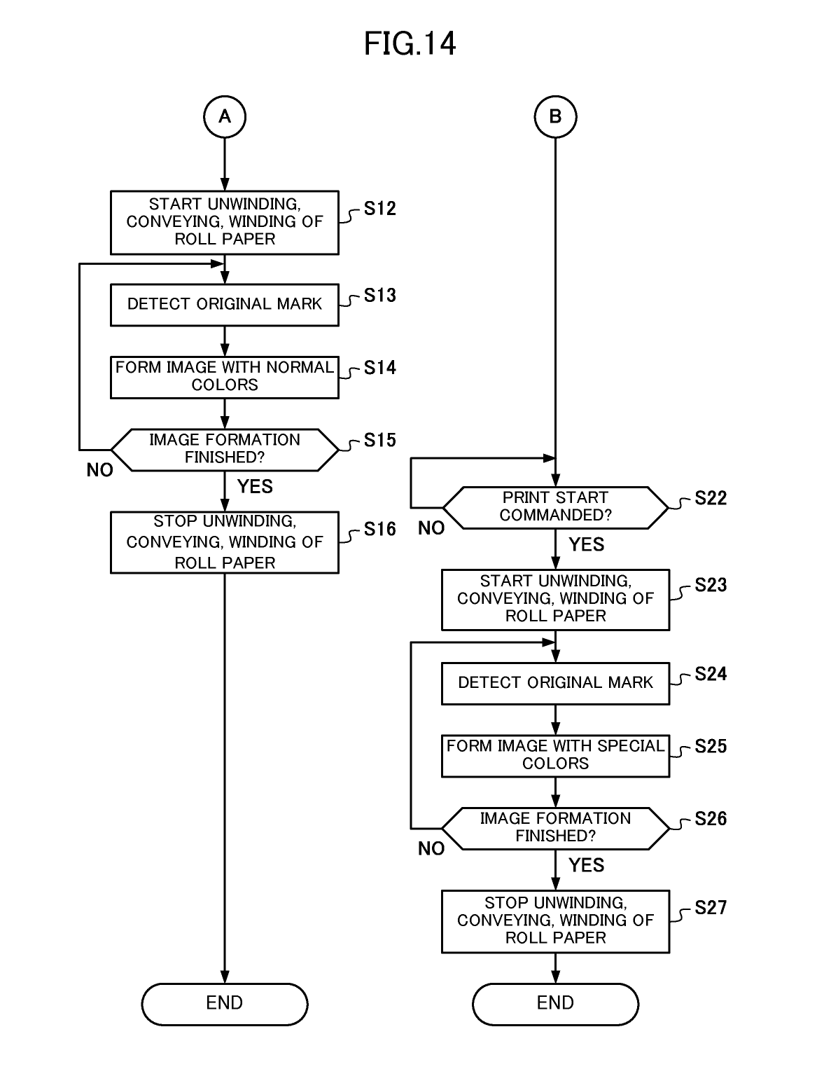

In the normal color printing system 10a, the image-forming apparatus 2a receives the first print data sent from the terminal apparatus 60 via the LAN communicator 51a or the USB communicator 52a (step S11). In the special color printing system 10b, the image-forming apparatus 2b receives the second print data sent from the terminal apparatus 60 via the LAN communicator 51b or the USB communicator 52b (step S21). Subsequent processes are explained with reference to the flowchart shown in FIG. 14.

In the normal color printing system 10a, upon receiving the first print data from the terminal apparatus 60, the image-forming apparatus 2a sends a paper supply request to the paper supply apparatus 1a, sends a winding request to the winding apparatus 9, and begins unwinding, conveying and winding the roll paper 3 (step S12). In the paper supply apparatus 1a that has received the paper supply request, the unwinder 82a unwinds the roll paper 3 held by the holder 8a in order from the beginning edge 77 to the ending edge 78 and supplies the roll paper 3 to the image-forming apparatus 2a via conveyance by the conveyor 83a.

When winding and conveying of the roll paper 3 begins, the detector 84a detects the original mark 75 recorded in advance on the roll paper 3 that is conveyed (step S13). Then, the image-forming apparatus 2a accomplishes image formation with normal colors (YMCK) on the conveyed roll paper 3 with the position of the detected original mark 75 as a reference (step S14).

While forming images in this manner, the image-forming apparatus 2a determines whether or not the commanded image formation has finished (step S15). When the commanded image formation has not finished (step S15: No), the process returns to step S13. That is to say, the normal color printing system 10a repeats the processes of steps S13-S14 and continues image formation until the commanded image formation concludes.

When the commanded image formation finishes (step S15: Yes), the image formation apparatus 2a sends a paper supply stop request to the paper supply apparatus 1a, sends a winding stop request to the winding apparatus 9 and causes unwinding, conveyance and winding of the roll paper 3 to stop (step S16). Then, printing in the normal color printing system 10a finishes.

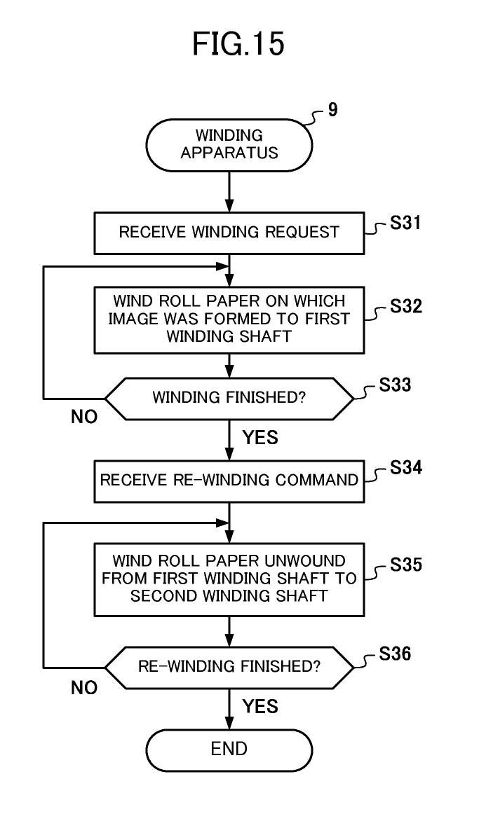

The winding process of the winding apparatus 9 is described with reference to the flowchart shown in FIG. 15. In the winding apparatus 9, when a winding request is received from the image-forming apparatus 2a (step S31), the winder 96 causes the first winding shaft 91 to rotate and winds the roll paper 3 on which the image-forming apparatus 2a accomplished image formation with the first toner in normal colors (YMCK) onto the first winding shaft 91 in order from the beginning edge 77 to the ending edge 78 (step S32).

During winding to the first winding shaft 91, the winder 96 determines whether or not winding has finished (step S33) and until winding finishes (step S33: No), successively winds the roll paper 3 discharged from the image-forming apparatus 2a around the first winding shaft 91. When a winding stop request is received from the image-forming apparatus 2a, the winder 96 halts rotation of the first winding shaft 91 and finishes winding (step S33: Yes).

When winding to the first winding shaft 91 concludes, the user prepares for the second winding (re-winding) by anchoring the ending edge 78 of the roll paper 3 wound on the first winding shaft 91 to the second winding shaft 92, as shown in FIG. 10A. When preparation for re-winding is completed, the user commands re-winding via an unrepresented operation unit with which the winding apparatus 9 is equipped.

When a re-winding command is received (step S34), the winder 97 causes the second winding shaft 92 to rotate and winds the roll paper 3 unwound from the first winding shaft 91 to the second winding shaft 92 in order from the ending edge 78 to the beginning edge 77 (step S35).

During winding to the second winding shaft 92, the winder 97 determines whether or not re-winding has finished (step S36), and until re-winding finishes (step S36: No), successively winds the roll paper 3 unwound from the first winding shaft 91 around the second winding shaft 92. When winding of the roll paper 3 to the beginning edge 77 ends, the winder 97 halts rotation of the second winding shaft 92, and finishes re-winding (step S36: Yes). Then, the winding process in the winding apparatus 9 finishes.

Returning to the explanation of the flowchart shown in FIG. 14, when printing in the normal color printing system 10a and winding by the winding apparatus 9 conclude, the roll paper 3 wound by the winding apparatus 9 is removed from the second winding shaft 92 as shown in FIG. 11 and attached to the paper supply apparatus 1b of the special color printing system 10b. In addition, the winding apparatus 9 is mounted on the special color printing system 10b. When this kind of printing preparation is completed, the user inputs a command for printing with special colors via an operation panel 54b of the image-forming apparatus 2b, for example, and printing in the special color printing system 10b begins.

That is to say, during printing by the normal color printing system 10a and winding by the winding apparatus 9, the image-forming apparatus 2b that has received the second print data from the terminal apparatus 90 in the special color printing system 10b determines whether or not the start of printing has been commanded (step S22), and while the start of printing has not been commanded (step S22: No), waits.

When the start of printing is commanded (step S22: Yes), the image-forming apparatus 2b sends a paper supply request to the paper supply apparatus 1b, sends a winding request to the winding apparatus 9 and starts unwinding, conveying and winding of the roll paper 3 (step S23). In the paper supply apparatus 1b that has received the paper supply request, the unwinder 82b unwinds the roll paper 3 held on the holder 8b in order from the beginning edge 77 to the ending edge 78, and supplies the roll paper 3 to the image-forming apparatus 2b via conveyance by the conveyor 83b.

When winding and conveying of the roll paper 3 begins, the detector 84b detects the original mark 75 recorded on the conveyed roll paper 3 (step S24). Then, the image-forming apparatus 2b accomplishes image formation with special colors on the conveyed roll paper 3 with the position of the detected original mark 75 as a reference (step S25). In the winding apparatus 9 that has received a winding request, the winder 96 successively winds the roll paper 3 on which images have been formed.

During this kind of image formation the image-forming apparatus 2b determines whether or not the commanded image formation has finished (step S26), and when the commanded image formation has not finished (step S26: No), the process returns to step S24. That is to say, the special color printing system repeats the processes of steps S24-S25 and continues image formation until the commanded image formation concludes,

When the commanded image formation finishes (step S26: Yes), the image-forming apparatus 2b sends a paper supply stop request to the paper supply apparatus 1b, sends a winding stop request to the winding apparatus 9 and stops unwinding, conveying and winding of the roll paper 3 (step S27). Then, printing in the special color printing system 10b and the printing system 100 concludes.

As described above, the printing system 100 according to the first exemplary embodiment realizes multi-color printing with toner in a maximum of eight colors by successively forming images using the two image-forming apparatuses 2a and 2b corresponding to four-color color printing. Because printing with other colors of developing agents in addition to the typical four colors of YMCK is possible, it is possible to form white toner images with two layers superimposed by the two Image-forming parts 21w1 and 21w2 forming images with white toner, for example, and it is possible to obtain a sufficient degree of white color even when a white toner image is formed in a deep base area. In addition, because it is fine to prepare two image-forming apparatuses corresponding to four-color color printing having the same hardware composition, it is not necessary to prepare a large special apparatus corresponding to color printing with five or more colors.

In addition, the printing system 100 according to the first exemplary embodiment, after image formation in the first image-forming apparatus 2a, forms an image with the second image-forming apparatus 2b on the roll paper 3 on which fixing by the fuser apparatus 40a has already been completed. Consequently, the layer depth of the developing agent to be fixed by the fuser apparatus does not become too thick and it is possible to prevent deterioration of fixing precision.

Furthermore, in the winding apparatus 9, after the first winding shaft 91 has wound the roll paper 3 on which an image was formed by the image-forming apparatus 2a, the second winding shaft 92 rewinds and again winds the roll paper 3 wound around the first winding shaft 91. As a result, the two image-forming apparatuses 2a and 2b both form images on the roll paper 3 unwound in order from the beginning edge 77, so image formation is possible with the same original mark 75 recorded on the roll paper 3 as a position reference. In addition, in the second image formation, a complex process such as causing the image to reverse up and down or left and right is unnecessary while forming the special color print data 73, so it is possible to realize multi-color printing using the two image-forming apparatuses 2a and 2b with a simple composition.

### Second Exemplary Embodiment

Below, a printing system according to a second exemplary embodiment of the present disclosure is described.

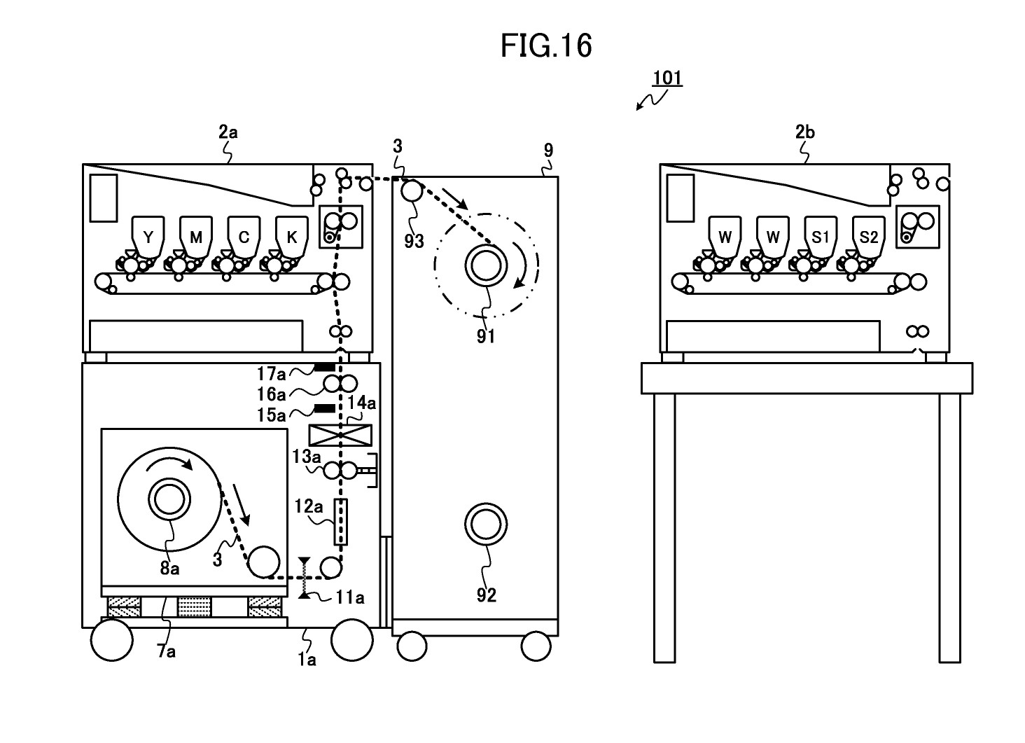

FIG. 16 shows the composition of a printing system according to the second exemplary embodiment. A printing system 101 comprises an image-forming apparatus 2a for forming images using developing agent in the four colors of YMCK, an image-forming apparatus 2b for forming images using developing agent in special colors other than YMCK, a paper supply apparatus 1a and a winding apparatus 9. That is to say, the printing system 100 according to the above-described first exemplary embodiment was provided with two paper supply apparatuses 1a and 1b. In contrast, the printing system 101 according to the second exemplary embodiment is not provided with a second paper supply apparatus 1b.

During the first image formation with normal colors (the four colors of YMCK), as shown in FIG. 16 the image-forming apparatus 2a that functions as the first image-forming unit is placed on top of the paper supply apparatus 1a. Furthermore, the paper supply apparatus 1a and the image-forming apparatus 2a constitute a system equivalent to the normal color printing system 10a in the first exemplary embodiment.

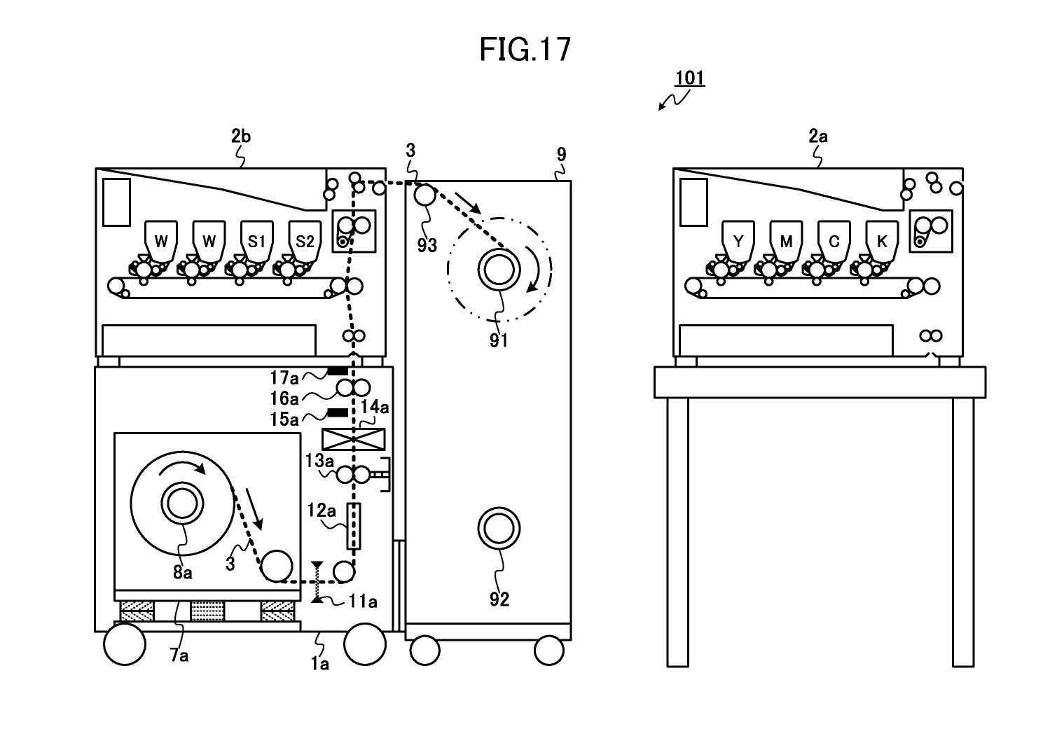

On the other hand, during the second image formation with special colors (white, and/or the like), as shown in FIG. 17 the image-forming apparatus 2b that functions as the second image-forming unit is placed on top of the paper supply apparatus 1a in place of the image-forming apparatus 2a. Furthermore, the paper supply apparatus 1a and the image-forming apparatus 2b constitute a system equivalent to the special color printing system 10b in the first exemplary embodiment.

That is to say, the paper supply apparatus 1a in the second exemplary embodiment functions as both of the two paper supply apparatuses 1a and 1b in the first exemplary embodiment. For example, the holder 8a provided in the paper supply apparatus 1a holds the roll paper 3 prior to images being formed by the image-forming apparatus 2a functioning as the first image-forming unit, and also functions as a holder that further holds the roll paper 3 after image formation by the image-forming apparatus 2a and winding by the winder 97. The unwinder 82a functions as a first unwinder that unwinds the roll paper 3 held by the holder 8a and supplies the roll paper 3 to the image-forming apparatus 1a, and functions as a second unwinder that unwinds the roll paper 3 held by the holder 8a and supplies the roll paper 3 to the image-forming apparatus 1b. The detector 84a functions as a first detector and a second detector for detecting the original mark 75 recorded in advance on the roll paper 3.

Through this kind of composition, it is possible for the printing system 101 according to the second exemplary embodiment to execute the same high-quality, multi-color printing with fewer constituent elements than the printing system 100 according to the first exemplary embodiment.

### Third Exemplary Embodiment

Below, a printing system according to a third exemplary embodiment of the present disclosure is described.

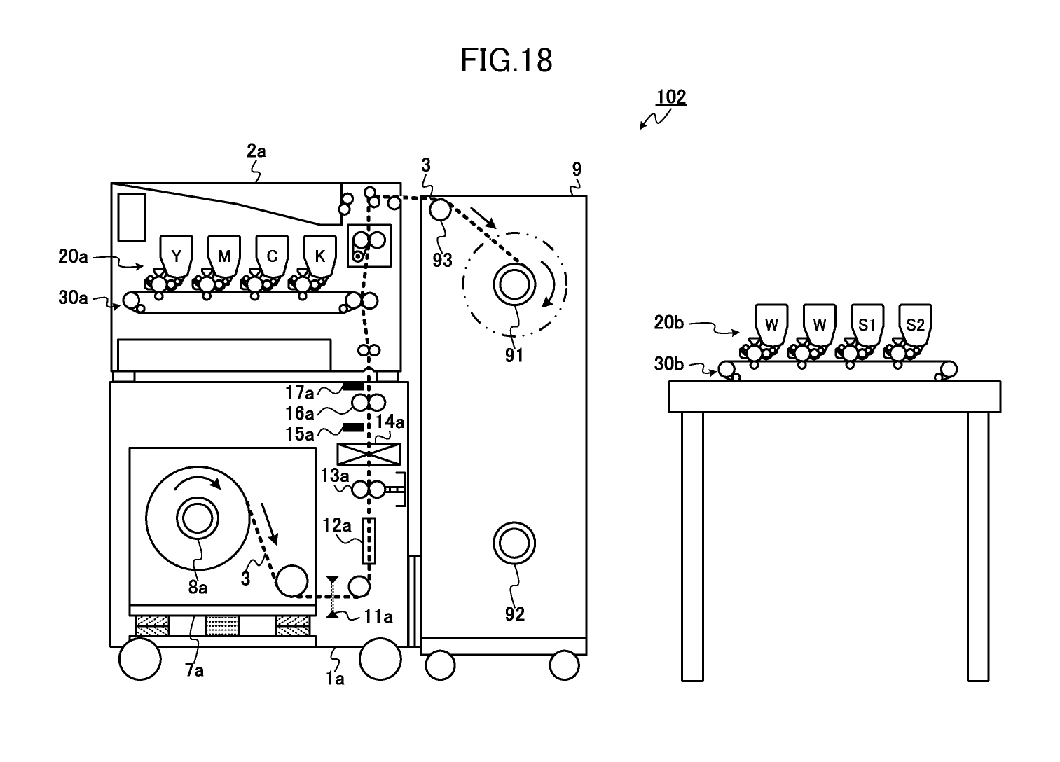

FIG. 18 shows the composition of a printing system according to a third exemplary embodiment. The printing system 102 comprises an image-forming apparatus 2a for forming images using developing agent in the four colors of YMCK, an image-forming unit 20b for forming images using developing agent in special colors other than YMCK, an intermediate transfer belt unit 30b, a paper supply apparatus 1a and a winding apparatus 9. That is to say, the printing system 101 according to the above-described second exemplary embodiment was provided with two image-forming apparatuses 2a and 2b. In contrast, the printing system 102 according to the third exemplary embodiment is not provided with the second image-forming apparatus 2b.

During the first image formation with normal colors (the four colors of YMCK), as shown in FIG. 18 the image-forming apparatus 2a comprising the intermediate transfer belt unit 30a and the image-forming unit 20a including the Image-forming parts 21y, 21m, 21c and 21k for the four colors of YMCK functions as the first image-forming unit.

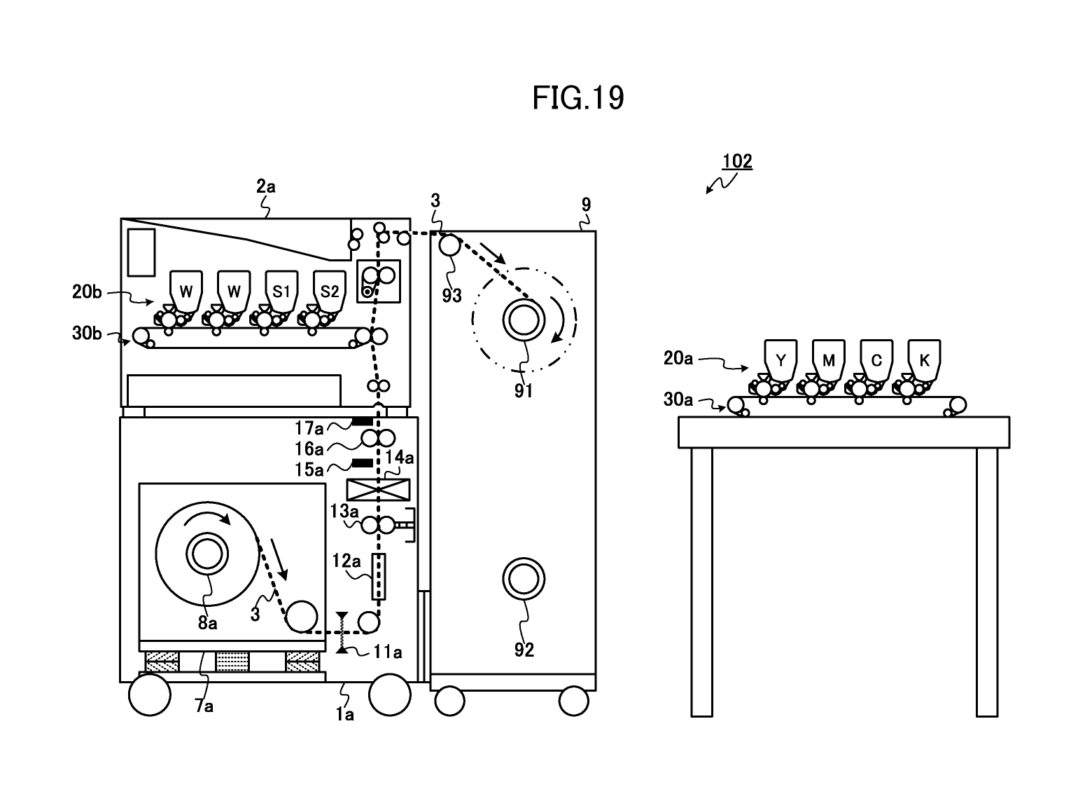

On the other hand, during the second image formation with special colors (white and/or the like), as shown in FIG. 19 the image-forming unit 20a and the intermediate transfer belt unit 30a inside the image-forming unit 2a are respectively replaced by the image-forming unit 20b including Image-forming parts 21w1, 21w2, 21s1 and 21s2 for special colors and the intermediate transfer belt unit 30b. Furthermore, the image-forming apparatus 2a comprising the image-forming unit 20b and the intermediate transfer belt unit 30b functions as the second image-forming unit.

That is to say, with the printing system 102 according to the third exemplary embodiment, one image-forming apparatus 2a removably houses constituent elements including image-forming units 21, and functions as both the first image-forming unit and the second image-forming unit. As a result, it is possible for the printing system 102 according to the third exemplary embodiment to execute the same high-quality, multi-color printing with fewer constituent elements than the printing system 101 according to the second exemplary embodiment.

(Variations)

The exemplary embodiments of the present disclosure were described above, but the above-described exemplary embodiments are intended to be illustrative and not limiting. That is to say, the exemplary embodiments of the present disclosure have various applications, and all variations should be included within the scope of the present disclosure.

For example, in the above-described exemplary embodiments, the image-forming apparatus 1a functioning as the first image-forming unit formed images using developing agent in normal colors (the four colors of YMCK) and the image-forming apparatus 1b functioning as the second image-forming unit formed images using developing agent in special colors (colors other than YMCK, including white). However, the combinations of colors of developing agent in the first image-forming unit and the second image-forming unit are not limited thereby, as any combination would be fine.

In addition, in the above-described exemplary embodiments, an original mark 75 was recorded in advance as a reference mark on the roll paper 3. However, in the printing system according to the present disclosure, if it is possible to form the first toner image on the roll paper 3 using another positioning reference, it is possible to use roll paper 3 in which the original mark 75 is not recorded.

When the original mark 75 is not recorded in advance on the roll paper 3, in the normal color printing system 10a the image-forming apparatus 2a records a reference mark when executing the first image formation on the roll paper 3 unwound by the unwinder 82a. To explain more specifically, the image-forming apparatus 2a records a reference mark at constant intervals at multiple positions including near the beginning edge 77 (for example, at the front end of the region where the first developing agent image is formed) of the roll paper 3. Furthermore, in the succeeding special color printing system 10b, the detector 84b detects the reference mark recorded on the roll paper 3 and the image-forming apparatus 2b executes the second image formation with the reference mark as a position reference. Through this, poisoning in second image formation is easy even when no original mark 75 is recorded in advance on the roll paper 3.

In addition, in the above-described exemplary embodiments, the printing systems 100, 101 and 102 executed multi-color printing on the roll paper 3. However, the printing system according to the present disclosure is not limited to a paper medium, that is to say the roll paper 3, and may execute multi-color printing on a roll-wound recording medium of another material, such as a film recording medium and/or the like.

While it is naturally possible to provide a composition for realizing the functions according to the present disclosure as a printing system prepared in advance, it is also possible through application of programs to cause an existing information processing apparatus and/or the like to function as the printing system according to the present disclosure. That is to say, it is possible for a program for realizing the functional composition of the printing systems 100, 101 and 102 illustrated by the above-described exemplary embodiments to be executed by a CPU and/or the like controlling an existing information processing apparatus and/or the like and through this to cause the apparatus to function as the printing system according to the present disclosure. In addition, it is possible for the printing method according to the present disclosure to be executed using the printing system.

In addition, the method of applying this kind of program is arbitrary. The program can be stored on a computer-readable non-transitory recording medium such as a flexible disk, CD (Compact Disc)-ROM, DVD (Digital Versatile Disc)-ROM, memory card and/or the like. Furthermore, it is possible to overlay the program on carrier waves and to apply such via a communications medium such as the Internet and/or the like. For example, it would be fine to post and distribute the program via a BBS (Bulletin Board System) on a communication network. Furthermore, it would be fine to have a composition such that the above-described processes can be executed by activating this program and similarly executing other application programs under control of the OS (Operating System).

Modifications and variations can be made without departing from broader spirit and scope of the present disclosure. It should be noted that the above embodiments are meant only to be illustrative of those embodiments and are not intended to be limiting the scope of the present disclosure. Accordingly, the scope of the present disclosure should not be determined by the embodiments illustrated, but by the appended claims. It is therefore the intention that the present disclosure be interpreted to include various modifications that are made within the scope of the claims and their equivalents.

What is claimed is:

1. A printing apparatus, comprising:
a printing unit that prints images on a recording medium unwound by an unwinder;
a first winder that winds the printed recording medium around a first winding shaft in order from a beginning edge to an ending edge of the recording medium; and
a second winder that rewinds the recording medium wound around the first winding shaft, and winds the rewound recording medium around a second winding shaft in order from the ending edge to the beginning edge of the recording medium.

2. The printing apparatus according to claim 1, wherein:
a reference mark is recorded in advance on the recording medium; and
the printing unit further comprises a detector that detects the reference mark on the recording medium, and prints an image on the recording medium using a position of the detected reference mark as a reference.

3. The printing apparatus according to claim 1, wherein the first winding shaft and the second winding shaft are provided perpendicular to a common surface so that the shaft directions are mutually parallel.

4. A printing system, comprising:
a first image-forming unit that forms a first developing agent image on a recording medium unwound by a first unwinder;
a first winder that winds the recording medium on which the first developing agent image was formed around a first winding shaft in order from a beginning edge to an ending edge of the recording medium;
a second winder that rewinds the recording medium wound around the first winding shaft, and winds the unwound recording medium around a second winding shaft in order from the ending edge to the beginning edge of the recording medium;
a second unwinder that unwinds the recording medium wound around the second winding shaft in order from the beginning edge to the ending edge of the recording medium; and
a second image-forming unit that forms a second developing agent image on a surface of the recording medium unwound by the second unwinder on which the first developing agent image was formed.

5. The printing system according to claim 4, wherein:
the first image-forming unit forms the first developing agent image with developing agent of multiple colors; and
the second image-forming unit forms the second developing agent image with developing agent of one or more colors not included in the multiple colors.

6. The printing system according to claim 4, wherein:
a reference mark is recorded in advance on the recording medium;
the printing system further comprises a first detector that detects the reference mark recorded on the recording medium unwound by the first unwinder; and
the first image-forming unit forms a first developing agent image on the recording medium using the reference mark detected by the first detector as a position reference.

7. The printing system according to claim 6, further comprising:
a second detector that detects the reference mark recorded on the recording medium unwound by the second unwinder; and
the second image-forming unit forms a second developing agent image on the surface of the recording medium on which the first developing agent image was formed, using the reference mark detected by the second detector as a position reference.

8. The printing system according to claim 4, wherein:
the first image-forming unit forms a reference mark on the recording medium unwound by the first unwinder;
the printing system further comprises a detector that detects the reference mark recorded on the recording medium unwound by the second unwinder; and
the second image-forming unit forms the second developing agent image on the surface of the recording medium on which the first developing agent image was formed, using the reference mark detected by the detector as a position reference.

9. The printing system according to claim 4, wherein the first winding shaft and the second winding shaft are provided perpendicular to a common surface so that the shaft directions are mutually parallel.

10. The printing system according to claim 4, further comprising:
a first holder that holds the recording medium prior to the first developing agent image being formed by the first image-forming unit; and
a second holder that holds the recording medium after the first developing agent image is formed by the first image-forming unit and after the recording medium has been wound by the second winder;
wherein the first unwinder unwinds the recording medium held by the first holder in order from the beginning edge to the ending edge of the recording medium and supplies the recording medium to the first image-forming unit; and
the second unwinder unwinds the recording medium held by the second holder in order from the beginning edge to the ending edge of the recording medium, and supplies the recording medium to the second image-forming unit.

11. The printing system according to claim 4, further comprising:
a holder that holds the recording medium prior to the first developing agent image being formed by the first image-forming unit;
wherein the first unwinder unwinds the recording medium held by the holder in order from the beginning edge to the ending edge of the recording medium, and supplies the recording medium to the first image-forming unit;
the holder further holds the recording medium after the first developing agent image is formed by the first image-forming unit and the recording medium is wound by the second winder; and
the second unwinder unwinds the recording medium held by the holder from the beginning edge to the ending edge of the recording medium, and supplies the recording medium to the second image-forming unit.

12. The printing system according to claim 5, wherein:
the developing agent of multiple colors includes developing agent in yellow, magenta, cyan and black; and
the developing agent of one or more colors includes developing agent of at least one color out of white, gold, silver, transparent and a special color for providing fluorescence or gloss, as colors not included in the multiple colors.

13. The printing system according to claim 12, wherein:
the developing agent of one or more colors includes the developing agent of white, as a color not included in the multiple colors; and
the second image-forming unit forms two white developing agent images with the developing agent of white, and forms the second developing agent image by overlaying the two white developing agent images.

14. A printing method, including:
forming a first developing agent image on an unwound recording medium;
winding the recording medium on which the first developing agent image was formed around a first winding shaft, in order from a beginning edge to an ending edge of the recording medium;
rewinding the recording medium wound around the first winding shaft, and winding the rewound recording medium around a second winding shaft, in order from the ending edge to the beginning edge of the recording medium;
unwinding the recording medium wound around the second winding shaft, in order from the beginning edge to the ending edge of the recording medium; and
forming a second developing agent image on a surface of the unwound recording medium on which the first developing agent image was formed.

15. A non-transitory computer-readable recording medium having stored thereon a program executable by a computer, the program controlling the computer to perform functions comprising:
forming a first developing agent image on an unwound recording medium;
winding the recording medium on which the first developing agent image was formed around a first winding shaft, in order from a beginning edge to an ending edge of the recording medium;
rewinding the recording medium wound around the first winding shaft, and winding the rewound recording medium around a second winding shaft, in order from the ending edge to the beginning edge of the recording medium;
unwinding the recording medium wound around the second winding shaft, in order from the beginning edge to the ending edge of the recording medium; and
forming a second developing agent image on a surface of the unwound recording medium on which the first developing agent image was formed.
